(19) United States
(12) Patent Application Publication
(10) Pub. No.: US 2009/0030932 A1
(43) Pub. Date: Jan. 29, 2009

(54) METHODS FOR DETECTING AND REMEDYING MISSED OPPORTUNITIES IN A SOCIAL NETWORK

(76) Inventors: Ralph Harik, Palo Alto, CA (US); Georges Harik, Palo Alto, CA (US); Praveen Krishnamurthy, San Francisco, CA (US)

Correspondence Address: MACPHERSON KWOK CHEN & HEID LLP, 2033 GATEWAY PLACE, SUITE 400, SAN JOSE, CA, 95110, US

(21) Appl. No.: 12/176,964

(22) Filed: Jul. 21, 2008

Related U.S. Application Data
(60) Provisional application No. 60/952,320, filed on Jul. 27, 2007.

(51) Int. Cl. G06F 17/30

(52) U.S. Cl. 707/102; 707/E17.009

(57) ABSTRACT

A method for identifying friend relationship in one or more on-line social networks includes creating a graph representing friend relationships among multiple participants of the social networks, in which the nodes of the graph represent the participants and each edge of the graph represents an existing friend relationship in the social networks between two of the participants. The resulting graph is then analyzed using, for example, a graph-theoretical technique to identify pairs of nodes that are unconnected in the graph. A score is then assigned between each identified pair of nodes. The score represents the likelihood that the participants corresponding to the identified pair of nodes are real life friends. The score for each identified pair may be computed based on the connectedness of a subgraph of the graph that includes the identified pair of nodes. One example of such a subgraph is a 4-node subgraph. The score may be computed based on the number of nodes connected to each node in the identified pair, or a variety of factors (e.g., profile information of the participants), in which each factor is provided a weight reflecting the contribution of the factor relative to the other factors. The weights may be adaptive. In one implementation, the graph is built based on collecting subgraphs of friend relationships for each participant, one participant at a time.

### CROSS REFERENCE TO RELATED APPLICATIONS

The present application is related to and claims priority to U.S. provisional patent application (“copending provisional patent application”), Ser. No. 60/952,320, entitled “Methods for Detecting and Remedying Missed Opportunities,” filed on Jul. 27, 2007. The disclosure of the copending provisional patent application is hereby incorporated by reference in its entirety.

### BACKGROUND OF THE INVENTION

1. Field of the Invention

The present invention relates to social networking on a wide area computer network.

2. Discussion of the Related Art

Social network websites allow members who join to designate other members on the social networks as “friends”. The process of adding friends into the network one at a time, even those who have joined a social network, is time-consuming and often leads people to having incomplete friend-lists. For example, Peter may be a Facebook user¹. Peter, however, may not be aware that his high school friend, John, is also on Facebook (and vice versa). Therefore, Peter and John would not have designated each other as “friends”. This leads to missed opportunities between Peter and John because, as often, social networks are good conduit for useful information flow, but only among those who are connected as “friends.” For example, Peter may post a news article that's visible on his profile, which is broadcast to Peter's friends. However, this article, which may be of great value to John, will be missed by John. ¹Facebook is a popular social network on the internet, especially among users in North America

### SUMMARY

The present invention provides a method for analyzing data on a social network for automatically suggesting or recommending useful connections that have been missed on the social network. According to one embodiment of the invention, the main data to be analyzed is the “friend graph”. A “graph” is a computational, mathematical or data structure defined by a collection of “nodes” (sometimes called “vertices”), and “edges” that connect between nodes. For a set of nodes V (in a social network analysis, these can represent the users, for example), the set of edges E can be used to represent pairwise “friend” relationships between the connected users. The present invention uses graph analysis—an area of study in computer science—to analyze graphs for a variety of applications.

According to one embodiment of the present invention, a method for identifying friend relationship in one or more on-line social networks includes creating a graph representing friend relationships among multiple participants of the social networks, in which the nodes of the graph represent the participants and each edge of the graph represents an existing friend relationship in the social networks between two of the participants. The resulting graph is then analyzed using, for example, a graph-theoretical technique to identify pairs of nodes that are unconnected in the graph. A score is then assigned between each identified pair of nodes. The score represents the likelihood that the participants corresponding to the identified pair of nodes are real life friends. The score for each identified pair may be computed based on the connectedness of a subgraph of the graph that includes the identified pair of nodes. One example of such a subgraph is a 4-node subgraph. The score may be computed based on the number of nodes connected to each node in the identified pair, or a variety of factors (e.g., profile information of the participants), in which each factor is provided a weight reflecting the contribution of the factor relative to the other factors. The weights may be adaptive. In one implementation, the graph is built based on collecting subgraphs of friend relationships for each participant, one participant at a time.

According to one embodiment, the scores for the identified pairs are ranked according to the scores. The ranking is used to determine an order for informing the participants corresponding to the identified nodes of a possibility of establishing a friend relationship. Scores that are less than a predetermined threshold may be disregarded.

According to one embodiment, the graph analysis reveals for each node one or more “good friend” nodes, where the good friend node share with the node more than a predetermined number of friend relationships. The score is enhanced by the presence of good friend nodes having friend relationships with both nodes of the identified pair.

According to one embodiment, the score may be decreased when the identified node is connected to one or more promiscuous nodes, where a promiscuous node is a node connected to more than a predetermined number of other nodes.

According to one embodiment of the present invention, the score is computed based on an input obtained from a participant corresponding to a node connected to both nodes of the identified pair.

A method of the present invention may be implemented as an application program running in an environment of one or more of the social networks, such as a widget.

The present invention is better understood upon consideration of the detailed description below in conjunction with the accompanying drawings.

### BRIEF DESCRIPTION OF THE DRAWINGS

FIG. 1 shows an almost complete graph having four nodes P1 to P4 and solid edges V1-V5.

FIG. 2 shows an almost complete graph having five nodes P1 to P5, and solid edges V1-V9.

### DETAILED DESCRIPTION OF THE PREFERRED EMBODIMENTS

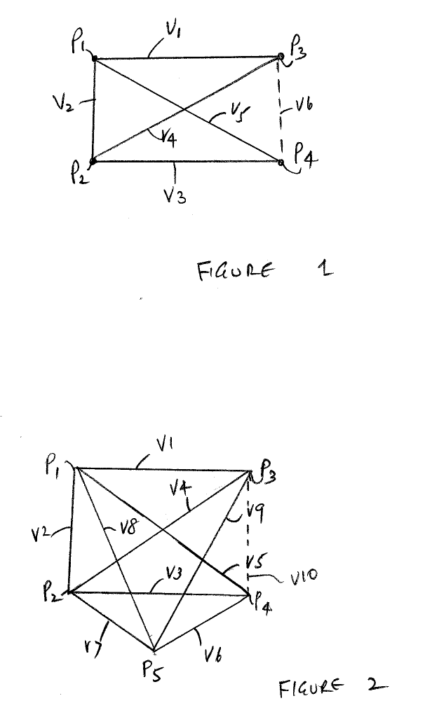

According to one method of the present invention, a graph analysis determines relationships that are likely to exist in the real world that are not represented in the social network. For example, as shown in FIG. 1, four people (referred to by the labels P1, P2, P3 and P4) are connected by an almost completely connected subgraph. Every two of people P1 to P4 in the subgraph, except P3 and P4 are connected by solid edges V1 to V5, representing a “friends” relationship in the social network. In other words, P1, P2 and P3 are friends to each other in the social network, and P1, P2 and P4 are friends to each other in the social network, but P3 and P4 are not friends in the social network. From experience, in such a situation, P3 and P4 are likely to be friends in real life (or at least be acquainted with each other). It is likely that an oversight situation or by happenstance that P3 and P4 are not actually also established as “friends” to each other on the social network. Using a conventional graph analysis, a program can identify these “almost completely connected” subgraphs, and can determine the likelihood (represented by dotted edge V6) that the pair of people P3 and P4 may be actual friends in the real world. A program can then use this computed likelihood to suggest to the people involved (or to their friends) that these two people should make “friends” with each other on the social network.

The graph analysis discussed above provides a basic approach. More advanced algorithms can be applied also. For example, in one embodiment, the likelihood of actual friendship in the real world may be represented by a “real friendship likelihood score.” One such score that can be used is based on the number of times a pair is the missing edge in otherwise complete subgraphs of size 4. This score therefore represents how similar P3's and P4's respective circles of friends are in the social network. This approach is illustrated in FIG. 2 in a graph including five nodes P1 to P5. As shown in FIG. 2, nodes (users) P3 and P4 belong to almost completely connected 4-node subgraphs (P1, P2, P3, P4) and (P1, P3, P4, P5). In this instance, an edge (dotted edge V10) connecting nodes P3 and P4 would make both subgraphs (P1, P2, P3, P4) and (P1, P3, P4, P5) completely connected. Accordingly, dotted edge V10 would be assigned a high score. The scores of the dotted edges can then be ranked. The resulting ranking can be used to determine the order in which the recommendations of possible “friends” relationship can be presented, or if any should be recommended at all.

Other more sophisticated analyses based on other factors may be used, for example decreasing a score to account for situations where there are reasons to doubt the reliability of the data. For example, one situation relates to “promiscuous” people² who have unlikely large (in real life) groups of friends. Therefore, if users P3 and P4 belong to very large almost completely connected subgraphs of “promiscuous” users P1 and P2, the “real friendship likelihood score” on the dotted edge between users P3 and P4 may be discounted. In another embodiment, additional factors outside of the graph structure may also be used. For example, the social network may provide access to additional information regarding both users P3 and P4 (e.g., both attended the University of Michigan). Such information is customarily known as the “profiles” of the users. These factors may be used to provide additional weights on the “real friendship likelihood score” relating users P3 and P4. One method to include a large number of factors is to compute the score based on a linear combination of the factors. The coefficient or weight for each factor in such as score can be assigned subjectively by the designer of the algorithm, or adaptive based on experience through computing relevant statistics on the population. ²The term “promiscuous” is used here merely to refer to the individual's an unlikely large group of friends (thus indicating unreliability in the data), not a value judgment on the person's life style.

In all of these cases, the program checks the social network to ensure that users P3 and P4 are not friends in the social network before recommending that they become friends. The recommendation, of course, may actually result in creating actual real life friendships. In another embodiment, the recommendation can also be mediated by first asking intermediaries P1 and P2 if users P3 and P4 should “really be made friends.” In this manner, an element of human judgment can be introduced into an otherwise algorithmic process.

The graph analysis may also be used to derive useful information about the state of one's circle of friends (e.g., which of a user's friends are likely to be “good friends³”). For ³ The term “good friends” here means closest friends. example, the graph analysis may reveal which ones of a user's friends share with the user the largest numbers of mutual friends. Such individuals are likely to be a user's “good friends.” According to another embodiment of the invention, a suggestion based on a mutual friend may be given a greater weight if the friend is a “likely good friend” to the users in the suggested “friend” relationship. For example, the “real friendship likelihood score” for user pair (P3, P4) may be enhanced according to the number of mutual friends that user P1 shares with users P3 or P4. This “likely good friend” information may even be shown to the user P1, and be used to determine how to order the suggestions that a user receives. For example, if user P3 is a good friend of user P1, the recommendation (P3, P4) may become more important.

The present invention is applicable to an application that accesses multiple social networks and derives a database of friends from all the underlying social networks. A program suggesting friend relationships according to the present invention may be implemented as an application program (e.g., a “plug in” program or a widget) running in the environment of the social network.

According to one embodiment of the invention, the program is even applicable to the situation where only one user's friends are known (and the relationships among the known friends also are known). This situation corresponds to the policies of many social networks which allow each user access only to the user's own friend list. In this case, no useful suggestions can be made for the user. However, using the graph algorithms discussed above (e.g., looking for almost completely connected 4-node subgraphs), the system can make introduction recommendations for the user's friends. Further, the program can integrate partial information collected over time to build a database that synthesizes asymptotically a complete view of the underlying graph.

Recommending friendships may take many forms, according to methods of the present invention. For example, in one embodiment, recommending a pair of users to become friends can be sent by email to both of the users, or by sending email to a mutual friend (e.g., users P1 or P2, in the example above). In another embodiment, a user P1 using the application, can find out that users P3 and P4 are not connected, but should be connected. User P1 can send an email to both users P3 and P4, or send a real-time message to both users through the social network's interface to real time messaging systems. In another embodiment, the email is accompanied by a suggestion that users P3 and P4 become users of the friendship suggestion application in order to obtain the suggestions targeting themselves.

The detailed discussion above is provided to illustrate specific embodiments of the present invention and is not intended to be limiting. Numerous modifications and variations within the scope of the present invention are possible. The present invention is set forth in the accompanying claims.

We claim:

1. A method for identifying friend relationship in one or more on-line social networks, comprising:
creating a graph representing friend relationships among multiple participants of the social networks, wherein nodes of the graph represent the participants and each edge of the graph represents an existing friend relationship between two of the participants;
analyzing the graph to identify pairs of nodes that are unconnected in the graph; and
assigning a score between each identified pair of nodes.

2. A method as in claim 1, wherein the score represents the likelihood that the participants corresponding to the identified pair of nodes are real life friends.

3. A method as in claim 1, wherein the score for each identified pair is computed based on the connectedness of a subgraph of the graph which includes the identified pair of nodes.

4. A method as in claim 3, wherein the subgraph is a 4-node subgraph.

5. A method as in claim 1, wherein the score is computed based on the number of nodes connected to each node in the identified pair.

6. A method as in claim 1, wherein the score is computed based on a plurality of factors each provided a weight reflecting the contribution of the factor relative to the other factors.

7. A method as in claim 6, wherein the weights are adaptive.

8. A method as in claim 6, wherein the factors include information obtained from the profiles of the participants corresponding to the identified pair.

9. A method as in claim 6, wherein the factors include information obtained from the profiles of the participants corresponding to the identified pair that is common to both the participants.

10. A method as in claim 6, wherein the graph analysis reveals for each node one or more “good friend” nodes, wherein each good friend node share with the node more than a predetermined number of friend relationships.

11. A method as in claim 10, wherein the score is enhanced by the presence of good friend nodes having friend relationships with both nodes of the identified pair.

12. A method as in claim 1, further comprising ranking the identified pairs according to the scores.

13. A method as in claim 1, further comprising informing the participants corresponding to the identified nodes of a possibility of establishing a friend relationship.

14. A method as in claim 1, wherein creating a graph comprises building the graph based on collecting subgraphs of friend relationships for each participant, one participant at a time.

15. A method as in claim 1, wherein the score is decreased when the identified node is connected to one or more promiscuous nodes, wherein each promiscuous node is connected to more than a predetermined number of other nodes.

16. A method as in claim 1, wherein the score is computed based on an input obtained from a participant corresponding to a node connected to both nodes of the identified pair.

17. A method as in claim 1, wherein the method is embodied in an application program running in an environment of one or more of the social networks.

18. A method as in claim 17, wherein the application program is embodied as a widget.
